(19) United States
(12) Patent Application Publication
(10) Pub. No.: US 2005/0286409 A1
(43) Pub. Date: Dec. 29, 2005

(54) Apparatus and method for transmitting/receiving uplink random access channel in mobile communication system

(75) Inventors: Seok-Hyun Yoon, Suwon-si (KR); Jung-Min Ro, Seoul (KR); Jin-Kyu Koo, Suwon-si (KR); Su-Ryong Jeong, Suwon-si (KR); Dong-Seek Park, Yongin-si (KR); Young-Kwon Cho, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/165,974

(22) Filed: Jun. 24, 2005

(30) Foreign Application Priority Data
Jun. 25, 2004 (KR) 48392/2004

(51) Int. Cl. H04J 11/00

(52) U.S. Cl. 370/210

(57) ABSTRACT

An apparatus and method for transmitting/receiving an random access channel (RACH) signal in a broadband wireless communication system where a total uplink frequency band is divided into M sub-bands are provided. In the RACH transmitting apparatus, a generator generates an access code. A sub-carrier allocator divides the access code into M sub-blocks and allocates each of the M sub-blocks to successive sub-carriers in a sub-band. An inverse fast Fourier transform (IFFT) processor generates an orthogonal frequency division multiplexing (OFDM) symbol by performing an IFFT on the allocated sub-blocks.

### PRIORITY

This application claims priority under 35 U.S.C. § 119 to an application entitled “Apparatus And Method For Transmitting/Receiving Uplink Random Access Channel In An Orthogonal Frequency Division Multiple Access Mobile Communication System” filed in the Korean Intellectual Property Office on Jun. 25, 2004 and assigned Serial No. 2004-48392, the contents of which are hereby incorporated by reference.

### BACKGROUND OF THE INVENTION

1. Field of the Invention

The present invention relates generally to an apparatus and method for transmitting/receiving a random access channel (RACH) in a mobile communication system, and in particular, to an apparatus and method for estimating uplink channel quality on a sub-band-by-sub-band basis using an RACH and dynamically allocating uplink resources based on the estimated uplink channel quality in an orthogonal frequency division multiple access (OFDMA) communication system.

2. Description of the Related Art

The 3^{rd} Generation (3G) mobile communication system which is also known as the International Mobile Telecommunications-2000 (IMT-2000) was developed for providing at advanced wireless multimedia service, global roaming and high-speed data service. The 3G mobile communication system was developed to transmit data at a high rate to satisfy increased serviced data demands.

High speed downlink packet access (HSDPA) and enhanced uplink data channel (EUDCH), which are currently being standardizes in the 3^{rd} Generation Partnership Project (3GPP), a standardization organization for the 3G mobile communication system, have adopted adaptive modulation and coding (AMC), hybrid automatic retransmission request (HARQ) and fast cell search (FCS) to support high-speed packet data transmission.

Among the techniques for high-speed packet service, AMC will be described below.

AMC is a data transmission scheme that adapts a modulation scheme and a coding scheme to the channel state between a cell, that is, a base station (BS) and a mobile station (MS), to thereby increase use efficiency across the entire cell. In AMC, a channel signal is encoded and modulated in a chosen modulation and coding combination from among a plurality of preset modulation schemes and coding schemes. A modulation and coding combination is usually called a modulation and coding scheme (MCS) and a plurality of MCSs are defined, from level 1 to level N according to the number of the MCSs. That is, AMC adaptively determines an MCS level according to the channel state between the MS and its serving BS, thereby improving the efficiency of the entire BS system. For example, a nearby MS has a small error probability in receiving signals from the BS. Thus, for the nearby MS, the BS selects a high-order modulation scheme such as 16-ary quadrature amplitude modulation (16 QAM) in which four bits form one signal, and a high code rate such as ¾. On the other hand, as a remote MS receives signals with a high error probability from the BS, the BS selects a low-order modulation scheme and a low code rate for the remote MS to receive signals without errors. AMC, HARQ and FCS can be adopted not only for HSDPA but also for all other high-speed data transmission schemes.

Mobile communication technology is now evolving from the 3G mobile communications systems to a 4G mobile communications systems. The 4G mobile communication system is currently being standardized for providing efficient interworking and integrated service between a wired communication network and a wireless communication network. This goes well beyond the simple wireless communication service which was provided by the first-generation mobile communication systems. Accordingly, there is a need for one or more techniques which can enable the transmission of a large volume of data using a wireless communication network with a capacity which is near to that of a wired communication network. In addition, in the 4G mobile communication system, research is being undertaken on developing methods using dynamic channel allocation (DCA) to dynamically allocate channels to MSs based on their individual channel states for transmission of mass data.

Orthogonal frequency division multiplexing (OFDM), which is a special case of multi-carrier modulation (MCM), has gained prominence in high-speed data transmission over wired/wireless channels. In OFDM, a serial symbol sequence is converted to parallel symbol sequences and modulated to mutually orthogonal sub-carriers, prior to transmission.

Although hardware complexity was an obstacle to the widespread use of OFDM, recent advances in digital signal processing technology including fast Fourier transform (FFT) and inverse fast Fourier transform (IFFT) have enabled OFDM to be widely exploited in the fields of digital transmission technology.

OFDM, similar to conventional frequency division multiplexing (FDM), boasts optimum transmission efficiency in high-speed data transmission because first of all, it can transmit data on sub-carriers, while maintaining orthogonality among them. Especially, efficient frequency use attributed to overlapping frequency spectrums and robustness against frequency selective fading and multi-path fading further increase the transmission efficiency in high-speed data transmission. OFDM also reduces the effects of inter-symbol interference (ISI) by use of guard intervals and enables design of a simple equalizer hardware structure. Furthermore, since OFDM is robust against impulsive noise, it is increasingly utilized for the digital transmission technology.

A block diagram of a typical OFDM/OFDMA communication system is shown in FIG. 1. A BS (Base Station) transmitter 100 includes a cyclic redundancy check (CRC) inserter 111, an encoder 113, a resource assignment controller 115, a symbol mapper 117, a channel multiplexer (MUX) 119, a serial-to-parallel (S/P) converter 121, a pilot symbol inserter 123, an IFFT processor 125, a parallel-to-serial (P/S) converter 127, a guard interval inserter 129, a digital-to-analog (D/A) converter 131, and a radio frequency (RF) processor 133.

An MS (Mobile Station) receiver 150 includes an RF processor 151, an analog-to-digital (A/D) converter 153, a guard interval remover 155, an S/P converter 157, an IFFT processor 159, an equalizer 161, a pilot symbol extractor 163, a channel estimator 165, a P/S converter 167, a channel demultiplexer (DEMUX) 169, a resource assignment controller 171, a symbol demapper 173, a decoder 175, and a CRC remover 177.

For transmission from the BS transmitter 100, upon generation of user data bits and control data bits to be transmitted, the data bits and the control data bits are provided to the CRC inserter 111. The user data bits and control data bits are collectively referred to as “information data bits” and the control data includes resource assignment information that the resource assignment controller 115 applies, specifically adaptive modulation and coding scheme (AMCS) information (or MCS level information), channel multiplexing information, and transmit power information. The CRC inserter 111 attaches CRC bits to the information data bits. The resource assignment controller 115 determines the channel state between the BS and an MS based on channel quality information (CQI) fed back from an MS transmitter (not shown) and selects a coding rate, a modulation scheme, and a sub-channel according to the channel state. The CQI can be signal-to-noise ratio (SNR), for example.

The encoder 113 encodes the CRC-attached data in a predetermined coding scheme under the control of the controller 115, such as turbo coding or convolutional coding with a predetermined coding rate. For the length of an input information word b, and a coding rate A, that the resource assignment controller 115 tells the encoder 113, the length of an output codeword is m (=b/A). The resource assignment controller 115 controls either or both of the coding rate and the coding scheme depending on system situation

The symbol mapper 117 maps the coded data to modulation symbols in a predetermined modulation scheme, that is, on a signal constellation corresponding to a mapping method (or modulation order) that the resource assignment controller 115 assigns. For example, the symbol mapper 117 supports binary phase shift keying (BPSK), quadrature phase shift keying (QPSK), 8-ary Quadrature Amplitude Modulation (8 QAM), and 16 QAM. One bit (s=1) is mapped to one complex signal in BPSK, two bits (s=2) are mapped to one complex signal in QPSK, three bits (s=3) are mapped to one complex signal in 8 QAM, and four bits (s=4) are mapped to one complex signal in 16 QAM.

Consequently, for a relatively good channel state between the BS and the MS, the resource assignment controller 115 selects a modulation scheme with a higher order than that of the current modulation scheme, and a coding scheme with a higher coding rate than that of the current coding scheme. Needless to say, however good the channel state is, if the current modulation order is the highest available, the resource assignment controller 115 maintains the current modulation scheme. Also, if the current coding rate is the highest available, it maintains the current coding rate.

On the contrary, for a relatively bad channel state between the BS and the MS, the resource assignment controller 115 selects a modulation scheme with a lower order than that of the current modulation scheme, and a coding scheme with a lower coding rate than that of the current coding scheme. If the current modulation order is the lowest available, the resource assignment controller 115 maintains the current modulation scheme however bad the channel state is. Also, in the case of the lowest available coding rate, the resource assignment controller 115 maintains the current coding rate.

The channel multiplexer (Mux) 119 allocates the modulation symbols to a predetermined sub-channel (or sub-channels) under the control of the resource assignment controller 115. The resource assignment controller 115 selects an optimal sub-channel for the MS among total sub-channels available in the OFDM/OFDMA system according to the channel state between the BS and the MS. That is, the resource assignment controller 115 controls the channel MUX 119 to allocate to the MS a sub-channel that offers the best channel state for the MS. A sub-channel refers to a channel including at least one sub-carrier. Therefore, the channel MUX 119 allocates the transmission data to a good-state sub-channel according to a DCA scheme, thereby improving system performance and outputs channel-multiplexed serial modulation symbols. While not shown in FIG. 1, the resource assignment controller 115 controls transmit power for the sub-channel allocated to the MS.

The S/P converter 121 parallelizes (i.e., converts serial data into parallel data) the channel-multiplexed serial modulation symbols. The pilot symbol inserter 123 inserts pilot symbols into the parallel modulation symbols and the IFFT processor 125 performs an IFFT on the pilot-inserted modulation symbols. The P/S converter 127 serializes the parallel IFFT signals.

The guard interval inserter 129 inserts a guard interval into the serial signal. The guard interval is inserted to eliminate interference between the previous OFDM symbol and the current OFDM symbol in the OFDM communication system. At first, it was proposed that null data is inserted for a predetermined interval as a guard interval. The distinctive shortcoming of this guard interval is that in case of a wrong estimation of the start of an OFDM symbol at a receiver, interference occurs between sub-carriers thus increasing the wrong decision probability of the received OFDM symbol. Therefore, the guard interval is used in form of a “cycle prefix” or “cyclic postfix”. The cyclic prefix is a copy of a predetermined number of last bits of a time-domain OFDM symbol, inserted into a valid OFDM symbol, whereas the cyclic postfix is a copy of a predetermined number of first of the time-domain OFDM symbol, inserted into a valid OFDM symbol.

The D/A converter 131 converts the guard interval-inserted serial signal to an analog signal. The RF processor 133, including a filter and a front-end unit, processes the analog signal to an RF signal transmittable over the air and transmits the RF signal through a transmit antenna. The signal transmitted from the BS transmitter 100 experiences a multi-path channel and includes added noise, prior to arriving at a receive antenna in the MS receiver 150.

For reception in the MS receiver 150, the RF processor 151 downconverts the RF signal received through the receive antenna to a baseband signal. The A/D converter 153 converts the analog baseband signal to a digital signal.

The guard interval remover 155 removes a guard interval from the digital signal, and the S/P converter 157 parallelizes the guard interval-free signal. The FFT processor 159 performs an N-point FFT on the parallel signals and outputs the FFT signals to the equalizer 161 and the pilot symbol extractor 163.

The pilot symbol extractor 163 detects pilot symbols from the FFT signals. The channel estimator 165 performs channel estimation using the pilot symbols and provides the channel estimation result to the equalizer 161. The MS receiver 150 generates CQI corresponding to the channel estimation result and transmits the CQI to the BS transmitter 100 through a CQI transmitter (not shown).

The equalizer 161 channel-equalizes the FFT signals using the channel estimation result. The P/S converter 167 serializes the parallel equalized signals. The channel DEMUX 169 extracts a corresponding sub-channel signal (or sub-channel signals) from the serial signal under the control of the resource assignment controller 171. The resource assignment controller 171 controls the channel demultiplexing using the channel multiplexing information included in the control data received from the BS transmitter 100.

The symbol demapper 173 demodulates the sub-channel signal (or signals) in a predetermined demodulation method under the control of the resource assignment controller 171. The decoder 175 decodes the demodulated signal in a predetermined decoding method under the control of the resource assignment controller 171. The resource assignment controller 171 detects the AMCS, that is, MCS level used in the BS transmitter 100 from the received control data and controls the demodulation and decoding based on the AMCS. The demodulation and decoding methods correspond to the modulation and coding methods used in the BS transmitter 100. The CRC remover 177 removes CRC bits from the decoded data, thereby recovering the information data bits transmitted from the BS transmitter 100.

To dynamically allocate downlink resources (or channels), an MCS level, and transmit power in the OFDM/OFDMA system, the BS needs CQI which is fed back from the MS receiver. On the other hand, the uplink does not need CQI feedback because all radio resources are controlled by the BS. Accordingly, the BS estimates the uplink channel state and allocates resources based on the channel state, as typically done for uplink resource allocation.

The OFDM system generally divides the total available frequency band into a plurality of sub-channels or sub-bands. Thus, the BS needs information about all sub-channels, for resource allocation. This implies that each MS must transmit data on all the sub-channels, increasing uplink overhead with the number of the sub-channels. Hence, it is necessary to design an appropriate uplink signal that minimizes overhead, and an uplink DCA scheme using the uplink signal. In this context, a DCA using an RACH can be considered.

While the RACH is generally used to request a bandwidth, the OFDMA system adopts it for ranging. In this case, the BS estimates the time of arrival (TOA) and average transmit power of the RACH and correspondingly controls the transmission time and transmit power of the MS.

Despite signal distortion over frequency fading channels, conventionally, the RACH is distributed across sub-carriers on the frequency axis to avoid the situation where all sub-carriers experience excessive fading.

With the distribution of the RACH across sub-carriers, however, the access code of the RACH undergoes different fading characteristics, leading to a significant distortion of signals transmitted on the RACH. The resulting degradation in the auto-correlation and cross-correlation of the RACH code makes it difficult to detect signals transmitted on the RACH. Moreover, if the sub-carriers of the RACH are separated one from another, TOA estimation performance is decreased. To overcome this problem, the sub-carriers of the RACH can be grouped physically, but making it difficult to measure reception power appropriately due to the frequency selectivity of the channel. Accordingly, there is a need for designing a novel RACH with an improved performance of TOA and reception power estimation.

As described above, the use of the RACH for dynamic resource allocation requires re-design of its channel structure so that uplink channel quality is easily estimated, while improving the performance of TOA and reception power estimation. Furthermore, a DCA scheme using the novel RACH needs to be defined.

### SUMMARY OF THE INVENTION

An object of the present invention is to substantially solve at least the above problems and/or disadvantages and to provide at least the advantages below.

Accordingly, an object of the present invention is to provide a random access channel (RACH) transmitting apparatus and method for improving the performance of time of arrival (TOA) and reception power estimation.

Another object of the present invention is to provide an apparatus and method for transmitting an RACH for use in dynamic uplink resource allocation.

A further object of the present invention is to provide an apparatus and method for dynamically allocating uplink resources using an RACH.

Still another object of the present invention is to provide an apparatus and method for receiving an RACH to estimate an uplink channel state.

Yet another object of the present invention is to provide an RACH receiving apparatus and method for improving the performance of TOA and reception power estimation.

The above objects are achieved by providing an apparatus and method for transmitting/receiving an RACH signal in a broadband wireless communication system where a total uplink frequency band is divided into M sub-bands.

According to one aspect of the present invention, in an apparatus for transmitting an RACH signal in a broadband wireless communication system where a total uplink frequency band is divided into M sub-bands, a generator generates an access code. A sub-carrier allocator divides the access code into M sub-blocks and allocates each of the M sub-blocks to predetermined successive sub-carriers in a predetermined sub-band. An Inverse Fast Fourier Transform (IFFT) processor generates an Orthogonal Frequency Division Multiplexing (OFDM) symbol by performing an IFFT on the allocated sub-blocks.

According to another aspect of the present invention, in an apparatus for receiving an RACH signal in a broadband wireless communication system where a total uplink frequency band is divided into M sub-bands, an FFT processor generates a frequency-domain sequence by performing an L-point FFT on a signal received for a predetermined time period. An access code remover extracts sub-carriers delivering the RACH signal from the frequency-domain sequence and removes an access code component from the extracted sub-carrier signal. A demultiplexer demultiplexes the access code-free sequence into M sub-blocks and outputs each of the sub-blocks to a predetermined IFFT processor. Each of a plurality of IFFT processors performs an L-point IFFT on a received sub-block. Each of a plurality of power measurers calculates the power values of samples received from a predetermined IFFT.

According to a further aspect of the present invention, in a method of transmitting an RACH signal in a broadband wireless communication system where a total uplink frequency band is divided into M sub-bands, an access code to be transmitted is divided into M sub-blocks and each of the M sub-blocks is allocated to predetermined successive sub-carriers in a predetermined sub-band. An OFDM symbol is generated by performing an IFFT on the allocated sub-blocks.

According to still another aspect of the present invention, in a method of receiving an RACH signal in a broadband wireless communication system where a total uplink frequency band is divided into M sub-bands, a frequency-domain sequence is generated by performing an L-point FFT on a signal received for a predetermined time period. Sub-carriers delivering an RACH signal are extracted from the frequency-domain sequence and an access code component is removed from the extracted sub-carrier signal. The access code-free sequence is demultiplexed into M sub-blocks. An L-point IFFT is performed on each of the sub-blocks. The power value of each sample in each of the IFFT signals is calculated.

According to yet another aspect of the present invention, in a method of dynamically allocating uplink resources using an RACH in a broadband wireless communication system where a total uplink frequency band is divided into M sub-bands, a mobile station divides an RACH signal into M sub-blocks, maps the sub-blocks to the M sub-bands, and transmits the mapped sub-blocks to a base station. The base station measures the reception power of the RACH signal in each of the M sub-blocks and estimates the channel quality of each of the sub-bands on an uplink based on the measured reception power. The base station then determines a sub-band to be allocated to the mobile station based on the estimated channel qualities.

### BRIEF DESCRIPTION OF THE DRAWINGS

The above and other objects, features and advantages of the present invention will become more apparent from the following detailed description when taken in conjunction with the accompanying drawings in which;

FIG. 1 is a block diagram illustrating the configuration of a typical OFDM/OFDMA communication system;

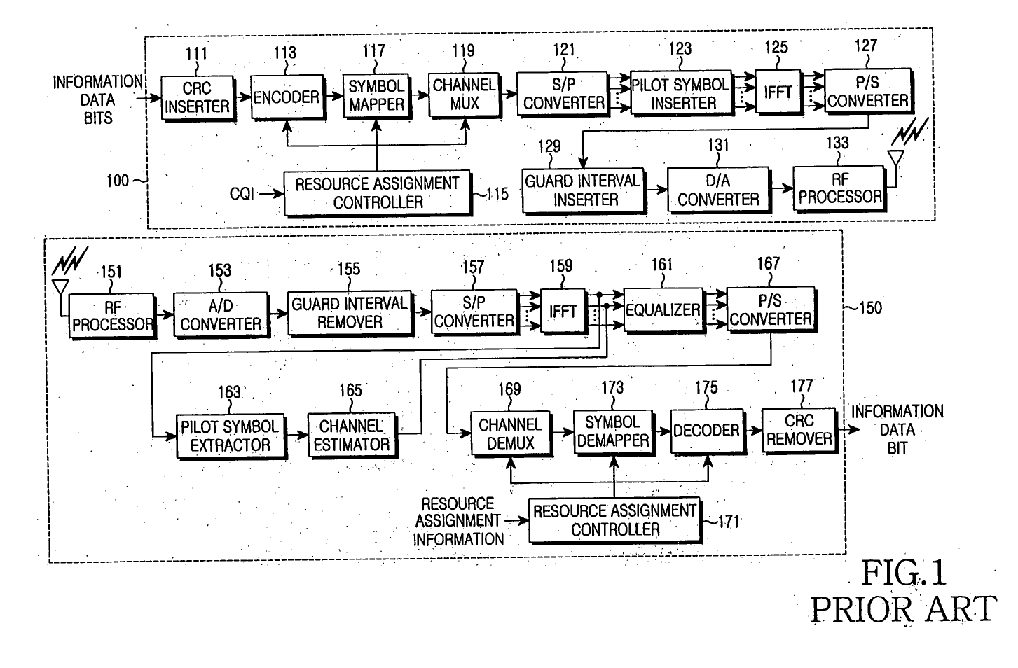

FIG. 2 is a diagram illustrating the structure of an RACH in an OFDMA system according to an embodiment of the present invention;

FIG. 3 is a block diagram illustrating an RACH transmitter according to an embodiment of the present invention;

FIG. 4 is a diagram illustrating a representation of an RACH signal on a time axis according to the present invention;

FIG. 5 is a block diagram illustrating an RACH receiver according to an embodiment of the present invention;

FIG. 6 is a flow diagram illustrating a signal flow for an uplink DCA procedure in the OFDMA system according to an embodiment of the present invention; and

FIG. 7 is a flowchart illustrating a procedure in a BS for measuring TOA, reception power, and the channel quality of each sub-band using the RACH in the OFDMA system according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an uplink DCA method using an RACH, as described hereinbelow. The present invention is divided, by and large, into three parts: the first part is about the structure of a RACH according to the present invention; the second part proposes an algorithm for estimating TOA, reception power, and uplink channel quality using the RACH according to the present invention; and the third part provides an uplink DCA method using the RACH according to the present invention.

As used herein, an “access code” refers to a sequence delivered on the RACH; a “sub-block” refers to each of segments into which the access code sequence is divided; and when the total frequency band is divided into a predetermined number of groups, each group is known as a “sub-band”.

### Structure of an RACH

In accordance with the present invention, the total uplink frequency band is divided into a plurality of sub-bands. Each sub-band is defined as a group of successive sub-carriers, and it is assumed that user mapping, MCS level allocation, and channel allocation are all carried out on a sub-band basis. A binary code of a predetermined length is delivered on the RACH, with each binary value of the code mapped to one sub-carrier. The present invention adapts block-wise mapping. Letting the number of sub-bands be denoted by M, an access code being a binary code of length N_{RACH} is divided into M sub-blocks, each sub-block mapped to predetermined sub-carriers in a corresponding sub-band.

The division of the RACH code into as many sub-blocks as the number of sub-bands and the distributed sub-block mapping prevents a situation where all sub-carriers experience excessive fading. Since this RACH configuration allows a receiver to calculate TOA on a sub-block basis, TOA estimation performance is improved. Above all things, the channel state of each sub-band can be measured from the reception power of an RACH signal mapped to the sub-band, thereby facilitating dynamic allocation of uplink resources.

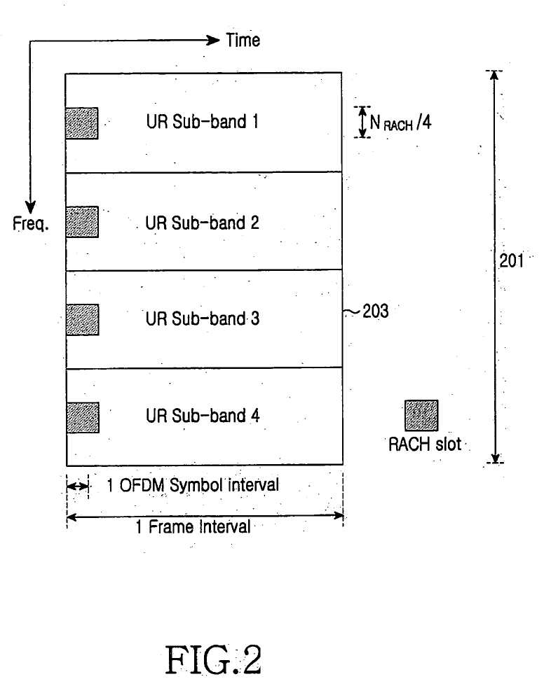

FIG. 2 is a diagram illustrating the structure of an RACH in an OFDMA system according to an embodiment of the present invention. The total uplink frequency band is divided into a plurality of sub-bands, for example, four sub-bands are used herein in the embodiment of the present invention. One frame 201 is defined to have four sub-bands and a predetermined number of OFDM symbols (not shown). An access code is N_{RACH} in length and divided into as many sub-blocks 203 as the number of sub-bands (M=4), i.e. four sub-blocks 203. Each sub-block 203 is mapped to predetermined successive sub-carriers in a corresponding sub-band.

Although the estimation accuracy of TOA increases with the size of the sub-block, transmission of the entire RACH code in one block makes it difficult to establish an estimation of average reception power due to frequency selection and makes it difficult to ascertain the channel information of the other sub-bands than the sub-band to which the RACH is mapped. On the contrary, if the access code is divided into more sub-blocks of a smaller size, reception power can be estimated more accurately because of frequency diversity, but the TOA estimation accuracy is decreased. Hence, it is preferable to divide a given access code into an appropriate number of sub-blocks.

In general, deciding the number (or length) of sub-blocks takes priority over deciding the length of an access code because the number of sub-blocks, equal to that of sub-bands for dynamic channel allocation, is not a parameter for the RACH itself to determine but rather is determined by a system design parameter. Once a sub-block length is determined in relation to a given number of sub-blocks, an access code length is automatically set. The sub-block length should be determined taking into account the accuracy of a TOA estimation. Considering an RACH signal detector which will be described in more detail below, a valid TOA estimation accuracy is approximately equal to the quotient of dividing an OFDM symbol length by “sub-block length×2”. For a sub-block length of 32 and an OFDM symbol length of Ts, the TOA estimation accuracy is about Ts/64. For a given a TOA estimation accuracy requirement (Treq), therefore, the sub-block length must be set to be larger than Ts/2Treq.

In the case of an initial ranging, the duration of an RACH probe signal is basically set longer than one OFDM symbol length, which will be described in more detail below.

A description will now be made of a configuration for transmitting the RACH.

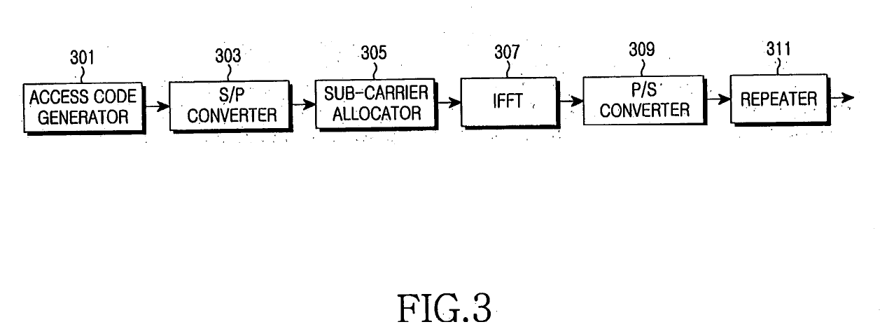

FIG. 3 is a block diagram illustrating an RACH transmitter according to an embodiment of the present invention. The RACH transmitter of the present invention includes an access code generator 301, an S/P converter 303, a sub-carrier allocator 305, an IFFT processor 307, a P/S converter 309 and a repeater 311.

In operation, the access code generator 301 generates an access code of length N_{RACH}. Alternatively, the access code generator 301 may read an access codes which is stored in a memory (not shown). The S/P converter 303 parallelizes the serial access code received from the access code generator 301.

The sub-carrier allocator 305 divides the parallelized access code into a number of sub-blocks equal to the number of sub-bands, and allocates sub-carriers to the sub-blocks such that every sub-block is mapped to predetermined sub-carriers in a different sub-band. The sub-carrier allocation amounts to providing the bits of the access code to their respective corresponding inputs (i.e. sub-carrier positions) of the IFFT processor 307.

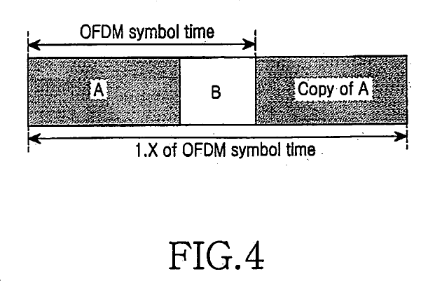

The IFFT processor 307 IFFT-processes the data received from the sub-carrier allocator 305 and outputs parallel IFT signals to the P/S converter. The P/S converter 309 converts the parallel IFFT signals to a serial data stream (sample data) defined as an OFDM symbol and outputs it to the repeater 311. The repeater 311 generates an RACH signal by repeating a predetermined first part of the OFDM symbol. The structure of the RACH signal is illustrated in FIG. 4.

A diagram illustrating a representation of an RACH signal on a time axis according to the present invention is shown in FIG. 4. A predetermined first part A of a valid OFDM symbol is copied and inserted after the end of the valid OFDM symbol, thereby creating the RACH signal.

Typically, an OFDM symbol time is defined as a time length(duration) corresponding to as many samples as the number of IFFT points. As illustrated in FIG. 4, the RACH signal has an extended time series as the part A of an OFDM symbol being a concatenation of parts A and B is repeated. A repetition factor (or repetition rate), n is between 0 and 1. Let a maximal TOA normalized to the OFDM symbol time length be denoted by TOAₘₐₓ. Then TOAₘₐₓ must satisfy the following condition.
n>TOAₘₐₓ Equation 1

Meanwhile, transmission/reception of the thus-designed RACH signal of “(1+n)×OFDM symbol length” takes an integer multiple of the OFDM symbol length, larger than (1+n+TOAₘₐₓ). For example, if TOAₘₐₓ is less than 0.5, n can be set to be 0.5 or less. In this case, a required RACH time length is 2 OFDM symbol lengths.

### Detection of RACH Probe Signal and Estimation of TOA and Reception Power

A new detection algorithm is needed to detect the novel RACH signal of the present invention. The present invention proposes a piece-wise detection technique in which the RACH signal is segmented, for detection.

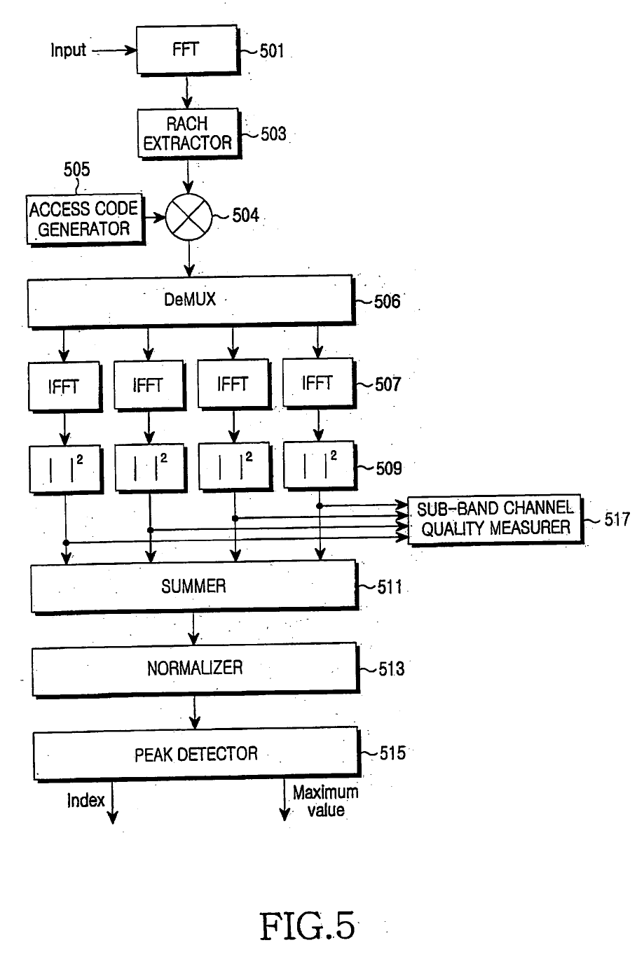

A detailed block diagram illustrating an RACH receiver according to an embodiment of the present invention is shown in FIG. 5. The RACH receiver according to the present invention includes an FFT processor 501, an RACH extractor 503, a multiplier 504, an access code generator 505, a demultiplexor (DEMUX 506), a plurality of IFFT processors 507, a plurality of power measurers 509, a summer 511, a normalizer 513, a peak detector 515, and a sub-band channel quality measurer 517. The following description is made on the assumption that the total uplink frequency band is divided into four sub-bands.

In operation, the FFT processor 501 performs an L-point FFT on L input sample data and outputs a frequency-domain sequence. The L sample data are within a common OFDM symbol window defined as a predetermined part of the time duration of the RACH. In the present example, it is assumed that MSs differ in TOA because they are separated away from a BS by distances. If the TOA difference as calculated between MSs is shorter than an OFDM symbol length, a time period as long as the OFDM symbol length starting from a half of the first OFDM symbol interval in the frame is set as the common OFDM symbol window for detection of the RACH signal.

The RACH extractor 503 extracts sub-carrier signals that deliver the RACH signal from the FFT sequence of L sub-carriers. The output of the RACH extractor 503 includes the components of an access code, a channel frequency gain and a group delay.

The access code generator 505 sequentially generates or downloads from a memory (not shown) a plurality of predetermined access codes. The multiplier 504 multiplies the sub-carrier signals by each of the access codes, thereby eliminating the access code component from the sub-carrier signals.

The DEMUX 506 constructs a plurality of sub-blocks by demultiplexing the multiplied sequence according to sub-bands and outputs each sub-block to a corresponding IFFT processor. Each of the IFFT processors 507 allocates the received sequence (i.e. sub-block) to predetermined sub-carriers and performs an L-point IFFT on the sub-block. Let a signal received on an n^{th} sub-carrier of an m^{th} sub-block be denoted by r_{m,n} and a k^{th} bit of an access code be denoted by x(k). Then, the output y_{m,l} of an m^{th} IFFT processor is given by

$${y}_{m , l} = {\sum }_{n = 0}^{{N}_{RACH} / M - 1} {r}_{m , n} \cdot x ( mM + n ) \cdot exp ( \frac{j2π \cdot nl}{L} ) \\ where l = 0 , 1 , … L - 1. \qquad Equation 2$$

Each of the power measurers 509 measures the reception power of each of the samples y_{m,l} received from a corresponding IFFT processor by calculating the absolute value of the sample and squares the absolute value. The summer 511 sums the power values received from the power measurers 509 at the same sample indexes according to

$${w}_{l} = {\sum }_{m = 0}^{M - 1} {\vert {y}_{m , l} \vert}^{2} where l = 0 , 1 , … , L - 1. \qquad Equation 3$$

The normalizer 513 detects the highest (or peak value), max w₁ of the power values received from the summer 511 and normalizes it by dividing it by the average of the power values. This operation is expressed as

$$\frac{max {w}_{l}}{\frac{1}{L} {\sum }_{l = 0}^{L - 1} {w}_{l}} \qquad Equation 4$$

The peak detector 515 compares the normalized power value with a predetermined threshold and outputs a decision value indicating whether the RACH has been received, according the comparison result. While not shown, the decision value is provided to the sub-band channel quality measurer 517 as well as to a higher-layer controller.

In addition, the peak detector 515 estimates a reception delay based on the sample index corresponding to the peak power value, estimates reception power using the reception delay, and outputs the estimated reception delay and the estimated reception power. The estimated reception delay \hat{d} expressed in samples is given by

$$\hat{d} = arg {min}_{l} {w}_{l} \qquad Equation 5$$

Meanwhile, if it is determined that the RACH signal has been received, the sub-band channel quality measurer 517 measures the channel quality of each sub-band using the power values received from the power measurers 509. If a real time delay measured in units of samples is d, the signal r_{m,l} received on the n^{th} sub-carrier of the m^{th} sub-block is expressed as

$${r}_{m , n} = \sqrt{P} H ( m , n ) \cdot x ( mM + n ) \cdot exp ( - \frac{j2π \cdot n \cdot d}{L} ) \qquad Equation 6$$

where P denotes the transmit power of the transmitter, H(*) denotes a channel gain, and exp( ) denotes a group delay component.

Therefore, the reception power of the m^{th} sub-block is derived from the estimate of Equation 5 by

$${\vert {y}_{m , d} \vert}^{2} = P {\sum }_{n = 0}^{{N}_{RACH} / M - 1} {\vert H ( m , n ) \vert}^{2} \qquad Equation 7$$

Once the reception power of each sub-block is measured using Equation 7, the BS can estimate the channel quality of each sub-band on the uplink channel. The BS then can allocate a sub-band in a good channel state to the MS based on the estimated channel quality of each sub-band. This will be detailed below.

### Operation of DCA Using RACH

As described above, the use of an uplink frame structure and a corresponding RACH structure of the present invention enables an estimation of the channel quality of each sub-band with a substantial degree of accuracy illustrated by by Equation 7 as well as enhancement of the basic RACH functionality and ranging. Hence, an uplink DCA can be applied to the system.

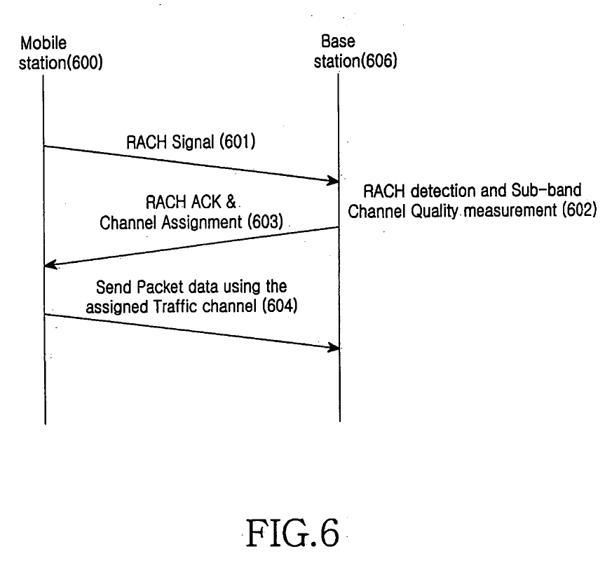

A flow diagram illustrating an uplink DCA operation using the RACH in the OFDMA system according to an embodiment of the present invention is shown in FIG. 6.

Referring to FIG. 6, the MS 600 transmits an RACH signal to the BS 606 in step 601. As described earlier, the MS 600 forms a plurality of sub-blocks by dividing an access code to be delivered on the RACH by the number of uplink sub-bands, and maps the sub-blocks to predetermined sub-carriers in different sub-bands, prior to transmission.

Meanwhile, the BS 606 determines whether the RACH signal has been received from the MS 600 in step 602. Upon receipt of the RACH signal, the BS 606 detects the reception power of the RACH signal on a sub-band-by-sub-band basis, estimates the uplink channel quality of each sub-band on the reception power, and allocates a sub-band in the best channel state to the MS 600.

In step 603, the BS 606 transmits to the MS 600 an acknowledgement (ACK) signal for the received RACH signal and a channel assignment message (or a resource assignment message) for allocating a channel in the sub-band in the best channel state to the MS 600. The MS 600 extracts channel information from the channel assignment message and transmits to the BS 606 packet data on a traffic channel according to the extracted channel information in step 604.

The operation of the BS will now be described in detail below.

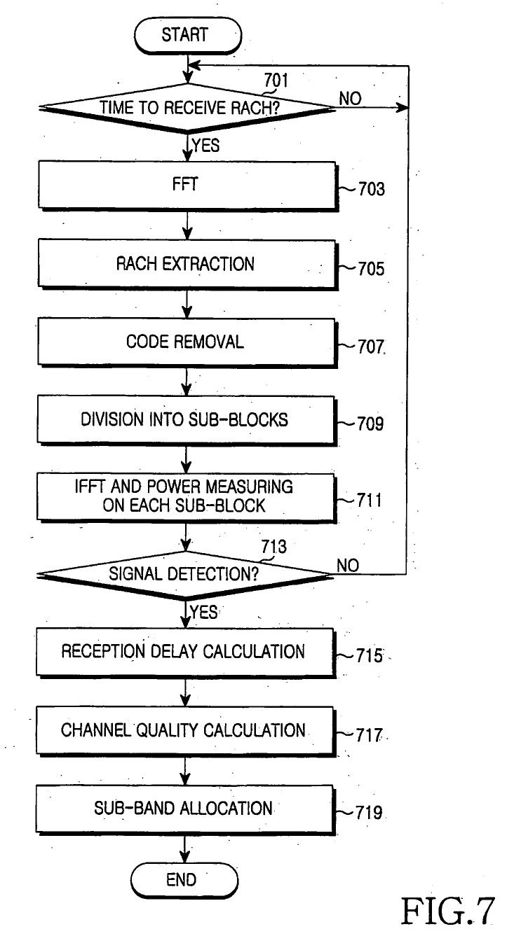

A flowchart illustrating an operation in the BS for measuring reception delay, reception power, and the channel quality of each sub-band using the RACH in the OFDMA system according to an embodiment of the present invention is shown in FIG. 7. The BS determines whether it is time to receive an RACH signal in step 701. For example, it can be set that the RACH is received at the state of each frame.

If it is time to receive the RACH signal, the BS acquires a frequency-domain sequence by performing an L-point FFT on a signal received for a predetermined time period in step 703. The predetermined time period is a common OFDM symbol window. For instance, the common OFDM symbol window can be time duration equal to an OFDM symbol length starting from a half of the first OFDM symbol interval of the frame.

In step 705, the BS extracts sub-carriers delivering the RACH signal from the frequency-domain sequence of L sub-carriers. The BS then eliminates an access code component by multiplying the extracted sub-carrier signals by known access codes in step 707.

The BS forms a plurality of sub-blocks by dividing the access code-free signal by the number of uplink sub-bands in step 709 and IFFT-processes each of the sub-blocks and calculates the reception powers of the IFFT signals, that is, the reception powers of (number of sub-blocks×L) samples in step 711.

In step 713, the BS sums power values at the same sample indexes, thereby producing L power values, normalizes the peak power value among the L power values by the average of the power values, and determines whether the RACH signal has been received by comparing the normalized power value with a predetermined threshold value.

If the normalized power value is less than the threshold valve, the BS determines that the BS determines that the RACH signal has not been received and the BS returns to step 701. If the normalized power value is equal to or greater than the threshold valve, the BS determines that the RACH signal has been received and proceeds to step 715.

In step 715, the BS estimates the reception delay of the uplink signal using the sample index corresponding to the peak power value. The BS calculates the reception power of each sub-block using the power values measured in step 711 and estimates the channel quality of each sub-band based on the power values in step 717. In step 719, the BS selects the best sub-band in terms of channel state and allocates a channel (or sub-channel) within the selected sub-band to the MS. The MS then transmits packet data to the BS on the allocated channel.

As can be understood from the foregoing description, the total uplink frequency band is divided into a plurality of sub-bands. An access code is divided by the number of sub-bands, and the resulting sub-blocks are distributedly mapped to the sub-bands. This RACH configuration increases the performance of TOA and reception power estimation and allows uplink channel quality to be estimated with a substantial level of accuracy on a sub-block-by-sub-block basis, as well. Therefore, uplink DCA is facilitated for an OFDMA system. Therefore, the present invention advantageously carries out uplink adaptation in an OFDMA communication system using AMC/DCA on a sub-band basis.

While the invention has been shown and described with reference to certain preferred embodiments thereof, it will be understood by those skilled in the art that various changes in form and details may be made therein without departing from the spirit and scope of the invention as defined by the appended claims.

1. An apparatus for transmitting a random access channel (RACH) signal in a broadband wireless communication system where an entire uplink frequency band is divided into M sub-bands, comprising:
a generator for generating an access code;
a sub-carrier allocator for dividing the access code into M sub-blocks and allocating each of the M sub-blocks to successive sub-carriers in a sub-band; and
an inverse fast Fourier transform (IFFT) processor for generating an orthogonal frequency division multiplexing (OFDM) symbol by performing an IFFT on the allocated sub-blocks.

2. The apparatus of claim 1, further comprising a repeater for generating the RACH signal by producing a copy of a first part of the OFDM symbol.

3. The apparatus of claim 1, wherein the RACH signal is generated by attaching a copy of a first part of the OFDM symbol after the OFDM symbol.

4. The apparatus of claim 2, wherein the copy is set to be greater than a maximum reception delay of the RACH signal.

5. The apparatus of claim 3, wherein the copy is set to be greater than a maximum reception delay of the RACH signal.

6. The apparatus of claim 1, wherein the RACH is a ranging channel.

7. An apparatus for receiving a random access channel (RACH) signal in a broadband wireless communication system where an entire uplink frequency band is divided into M sub-bands, comprising:
a fast Fourier transform (FFT) processor for generating a frequency-domain sequence by performing an L-point FFT on a RACH signal received for a set time period;
an access code remover for extracting sub-carriers delivering the RACH signal from the frequency-domain sequence and removing an access code component from the extracted sub-carrier signal;
a demultiplexer for demultiplexing the access code-free sequence into M sub-blocks and outputting each of the sub-blocks to one of an inverse fast Fourier transform (IFFT) processor;
a plurality of IFFT processors, each for performing an L-point IEFFT on a received sub-block; and
a plurality of power measurers, each for calculating the power values of samples received from an IFFT.

8. The apparatus of claim 7, wherein the access code remover comprises:
an extractor for extracting the sub-carrier signals delivering the RACH signal from the frequency-domain sequence;
an access code generator for sequentially generating access codes; and
a multiplier for multiplying the sub-carrier signals by the access codes and outputting the product to the demultiplexer.

9. The apparatus of claim 7, further comprising a signal detector for detecting a peak power using the power values of samples each having an index received from the plurality of power measurers, and estimating a reception delay and a reception power using the peak power and an index of a sample having the peak powe.

10. The apparatus of claim 9, wherein the signal detector comprises:
a summer for generating L power values by summing the power values of samples having the same index received from the power measurers; and
a peak detector for detecting a peak value from among the L power values, determining if the RACH signal has been received by comparing the peak power with a threshold valve, and if it is determined that the RACH signal has been received, estimating the reception delay and the reception power using the peak power and an index corresponding to a sample having the peak power valve.

11. The apparatus of claim 9, wherein the signal detector comprises:
a summer for generating L power values by summing the power values of samples having the same sample indexes received from the power measurers;
a normalizer for detecting a peak power value from among the L power values, and normalizing the peak power by dividing the peak power by the average of the L power values; and
a peak detector for determining if the RACH signal has been received by comparing the normalized peak power with a threshold valve, and if it is determined that the RACH signal has been received, estimating the reception delay and the reception power using the peak power and the sample index corresponding to a sample having the peak power valve.

12. The apparatus of claim 7, further comprising a sub-band channel quality measurer for calculating a reception power of each of the M sub-blocks using the power values of samples received from the power measurers, estimating a channel quality of each of the M sub-bands based on the reception power, and determining a sub-band to be allocated to a mobile station based on the estimated channel qualities.

13. The apparatus of claim 7, wherein the RACH is a ranging channel.

14. The apparatus of claim 7, wherein the RACH signal is mapped to successive sub-carriers in each of the M sub-bands.

15. The apparatus of claim 7, wherein the set time period is an orthogonal frequency division multiplexing (OFDM) symbol length starting from a half of a first OFDM symbol interval in a frame.

16. A method of transmitting a random access channel (RACH) signal in a broadband wireless communication system where an entire uplink frequency band is divided into M sub-bands, comprising the steps of:
dividing an access code to be transmitted into M sub-blocks and allocating each of the M sub-blocks to successive sub-carriers in a sub-band; and
generating an orthogonal frequency division multiplexing (OFDM) symbol by performing an inverse-fast-Fourier-transform (IFFT) on the allocated sub-blocks.

17. The method of claim 16, further comprising the step of generating the RACH signal by producing a copy of a first part of the OFDM symbol.

18. The method of claim 16, further comprising the step of generating the RACH signal by attaching a copy of a first part of the OFDM symbol after the OFDM symbol.

19. The method of claim 16, wherein the copy is set to be greater than a maximum reception delay of the RACH signal.

20. The method of claim 17, wherein the copy is set to be greater than a maximum reception delay of the RACH signal.

21. The method of claim 14, wherein the RACH is a ranging channel.

22. A method of receiving a random access channel (RACH) signal in a broadband wireless communication system where an entire uplink frequency band is divided into M sub-bands, comprising the steps of:
generating a frequency-domain sequence by performing an L-point fast-Fourier-transform (FFT) on a signal received for a set time period;
extracting sub-carriers delivering an RACH signal from the frequency-domain sequence and removing an access code component from the extracted sub-carrier signal to create an access code-free sequence;
demultiplexing the access code-free sequence into M sub-blocks;
performing an L-point IFFT on each of the M sub-blocks; and
calculating the power value of each sample in each of the IFFT signals.

23. The method of claim 22, wherein the access code removing step comprises the steps of:
extracting the sub-carrier signals delivering the RACH signal from the frequency-domain sequence;
sequentially generating access codes; and
multiplying the sub-carrier signals by the access codes.

24. The method of claim 22, further comprising the step of detecting a peak power using the power values, and estimating a reception delay and a reception power using the peak power and an index of a sample having the peak power.

25. The method of claim 24, wherein the reception delay and reception power estimating step comprises the steps of:
generating L power values by summing the power values at the same sample indexes;
detecting the peak value among the L power values, determining if the RACH signal has been received by comparing the peak power with a threshold valve; and
estimating the reception delay and the reception power using the peak power and the index of the sample corresponding to the peak power, if the RACH signal has been received.

26. The method of claim 24, wherein the reception delay and reception power estimating step comprises the steps of:
generating L power values by summing the power values at the same sample indexes;
detecting the peak value among the L power values, and normalizing the peak power by dividing the peak power by the average of the power values;
determining if the RACH signal has been received by comparing the normalized peak power with a predetermined threshold value; and
estimating the reception delay and the reception power using the peak power and the index of the sample corresponding to the peak power, if the RACH signal has been received.

27. The method of claim 22, further comprising the steps of:
calculating the reception power of each of the M sub-blocks using the power values; and
estimating the channel quality of each of the sub-bands based on the reception power.

28. The method of claim 27, further comprising the step of determining a sub-band to be allocated to a mobile station based on the estimated channel qualities.

29 The method of claim 27, wherein the RACH is a ranging channel.

30. The method of claim 27, wherein the RACH signal is mapped to successive sub-carriers in each of the M sub-bands.

31. A method of dynamically allocating uplink resources using a random access channel (RACH) in a broadband wireless communication system where an entire uplink frequency band is divided into M sub-bands, comprising the steps of:
dividing, by a mobile station, an RACH signal into M sub-blocks, mapping the sub-blocks to the M sub-bands, and transmitting the mapped sub-blocks to a base station;
measuring, by a base station, the reception power of the RACH signal in each of the M sub-blocks and estimating the channel quality of each of the sub-bands on an uplink based on the measured reception power; and
determining, by the base station; a sub-band to be allocated to the mobile station based on the estimated channel qualities.

32. The method of claim 31, further comprising the steps of:
transmitting to the mobile station a resource assignment message for allocating, by the base station, resources in the determined sub-band; and
extracting, by the mobile station, information from the resource assignment message and transmitting to the base station traffic data using the allocated resources according to the extracted information.

33. The method of claim 31, wherein the channel quality estimating step comprises the steps of:
generating a frequency-domain sequence by performing an L-point fast-Fourier-transform (FFT) on a signal received for a set time period;
extracting sub-carriers delivering an RACH signal from the frequency-domain sequence and removing an access code component from the extracted sub-carrier signal so as to create an access cod-free sequence;
demultiplexing the access code-free sequence into M sub-blocks;
performing an L-point IFFT on each of the sub-blocks;
calculating the power value of each sample in each of the IFFT signals;
calculating the reception power of each of the sub-blocks using the power values; and
estimating the channel quality of each of the sub-bands on the uplink using the power values.

34. The method of claim 31, wherein the RACH is a ranging channel.

35. The method of claim 31, wherein the RACH signal is mapped to successive sub-carriers in each of the sub-bands.
